(19) United States
(12) Patent Application Publication
(10) Pub. No.: US 2009/0015547 A1
(43) Pub. Date: Jan. 15, 2009

(54) Electronic Device with Physical Alert

(76) Inventors: Roger L. Franz, Mundelein, IL (US); Theodore R. Arneson, Ivanhoe, IL (US)

Correspondence Address: PHILIP H. BURRUS, IV, 460 Grant Street, Atlanta, GA, 30312, US

(21) Appl. No.: 11/777,035

(22) Filed: Jul. 12, 2007

(51) Int. Cl. G09G 5/00

(52) U.S. Cl. 345/156

(57) ABSTRACT

An electronic device (100) includes an actuation element (106) configured to alter an actuation element profile (108) of the actuation element (106) with respect to a housing (102) in response to a device event (110). Altering the actuation element profile (108) may include distally extending or changing the form factor of the actuation element (106). Device events, for example where the electronic device (100) is a radiotelephone (300), may include receipt of an incoming communication (310). When such an event occurs, the actuation element profile (108) of a call activation key (306) is altered. In response to the actuation element profile (108) being altered, a user (620) is alerted to the incoming communication (310). Shape memory alloy elements such as martensite, actuation element profile drivers such as electromagnetic driver (700), or actuation element profile motors such as a cam and follower motor (800) a may additionally be used to alter the actuation element profile (108).

### BACKGROUND

1. Technical Field

This invention relates generally to an electronic device configured to physically alert the user that an event has occurred, and more particularly to an electronic device for altering the physical form factor of the electronic device by tactile presentation of an actuation element.

2. Background Art

Mobile telephones and their audible ring tones have become commonplace in today's society. In the grocery store, bank, train, or bus, ring tones of mobile telephones have become a familiar sound. Ring tones have become so prevalent in fact, that some institutions, such as movie theaters and schools, have begun to restrict the use of audible ring tones.

Mobile telephone developers permit users to selectively silence ring tones. Two frequently implemented features are the silent mode and vibration mode. The silent mode mutes all audible ring tones, thus preventing the user from receiving any notice of an incoming communication. The vibration mode provides the user with a physical alert, as the mobile telephone vibrates rather than producing ring tone. The vibration is caused when a motor connected to an eccentric weight moves, thereby alerting the user that an incoming call or text message is pending.

Both the silent mode and the vibrating mode have limitations when in use. For example, as noted above, when a phone is in the silent mode, no alert is given for incoming communications. As such, the user may miss an important telephone call or text message. When in vibration mode, an audible noise may result from the vibration, which can sometimes frustrate the intended purpose of turning off the audible alert. This noise can be exacerbated when the mobile telephone rests upon a wooden or metal surface. For example, when resting on a hard surface, such as a school desk, the vibration of the mobile telephone may cause significant audible noise.

There is therefore a need for an electronic device, such as a mobile telephone, to provide physical, inaudible indicia to a user upon the occurrence of a device event, such as an incoming electronic communication.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of an electronic device comprising an actuation element configured to alter an actuation element profile relative to a housing in response to a device event in accordance with the invention.

FIG. 2 illustrates one embodiment of an actuation element distally extending in accordance with the invention.

FIG. 3 illustrates one embodiment of an actuation element telescopically extending in accordance with the invention in response to an incoming electronic communication.

FIG. 4 illustrates one embodiment of an actuation element comprising a navigation key in accordance with the invention.

FIG. 5 illustrates one embodiment of an electronic device comprising a deformable cover layer in accordance with the invention.

FIG. 6 illustrates one embodiment of an actuation element profile driver implemented to distally extend an actuation element as to alter an actuation element profile with respect to a housing in accordance with the invention.

FIG. 7 illustrates one embodiment of an electromagnetic driver implemented to distally extend an actuation element in accordance with the invention.

FIG. 8 illustrates one embodiment of an actuation element motor implemented to distally extend an actuation element in accordance with the invention.

FIG. 9 illustrates one embodiment of altering a form factor of an actuation element in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

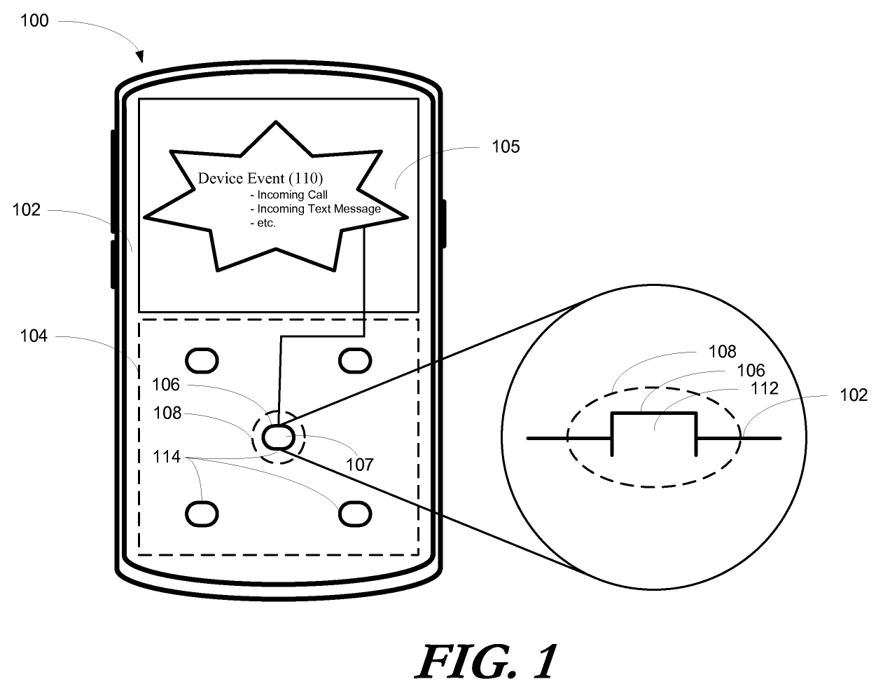

Turning to FIG. 1, illustrated therein is an electronic device 100 in accordance with one embodiment of the invention. The electronic device 100 may be, but is not limited to, any of a radiotelephone, a personal digital assistant, a pager, a computer, a portable computer, or other similar mobile communication device.

The electronic device 100 comprises, in addition to the elements discussed below, standard components for communication. For example, where the electronic device 100 is a radiotelephone, the electronic device 100 comprises a transmitter and a receiver (or a transceiver), a controller, a user interface, and a memory. The electronic device 100 also comprises a housing 102. In one embodiment, the housing 102 covers the entire electronic device 100 and defines at least a front surface, which may be planar or radiused, on one face of the electronic device 100.

The electronic device 100 has a user interface 104 on the front surface. The user interface 104 is configured to provide input and output capabilities for responding to device events, often incorporating one or more user actuatable elements, such as actuation elements 106. Device events may include incoming telephone calls, incoming text messages, incoming multimedia messages, low battery warnings, and the like.

In some embodiments, the user interface 104 may be extended beyond the area shown to additionally include a display 105. The display 105 notifies the user as to the present state of the electronic device 100, while the actuation elements 106, which are tactile buttons in one embodiment, allow the user to input data and control the device. By way of example, the words “new message” may appear on the display 105 following the receipt of a text message. One or more actuation elements 106 may be actuated to open and view the message.

The actuation element 106 has a corresponding actuation element profile 108 relative to the housing 102. The actuation element profile 108 is a physical form factor relative to the housing 102. Said differently, the actuation element profile 108 is comparison of physical shape or dimension relative to the housing 102. In one sense, the actuation element profile may be characterized by the height of the actuation element 106 relative to the housing 102. In another embodiment, the actuation element profile 108 may be characterized by a cross sectional shape of the actuation element 106. For example, in one embodiment, the actuation element 106 is positioned flush with the housing 102, thereby creating one actuation element profile. In another embodiment, the actuation element 106 may be protruding slightly above the housing 102, thereby creating a second actuation element profile.

The actuation element profile may alternatively be characterized by the surface area of the actuation element 106, or the surface area of the housing 102 covered by the actuation element 106. For example, in one embodiment, the actuation element 106 is balloon like, in that it may swell or contract. In such an embodiment, the actuation element 106 may cover the housing 102 with a first surface area when deflated and a second surface area when inflated.

In addition to the various actuation element form factors, the actuation element 106 may additionally take many physical forms, shapes, textures, and compositions. The particular shape, texture or composition will depend upon the type of electronic device 100, and its intended application.

In one embodiment, the actuation element 106 is as simple as a rigid button with a printed symbol disposed thereon, which a user physically depresses to perform the function associated with the printed symbol. By contrast, in another embodiment, as set forth in commonly assigned, copending U.S. patent application Ser. No. 11/684,454, filed Mar. 9, 2007, the actuation element 106 may be a proximity sensitive interface comprising an optical shutter device. In such an embodiment, the actuation element performs a function when the user's finger comes in proximity of the actuation element 106.

The actuation element 106 may additionally have an actuation element cross sectional shape 107. The actuation element cross sectional shape 107 may be, but is not limited to, any of the following shapes: a ramp, a rectangle, a plus, a circle, a semicircle, an oval, a triangle, an alphanumeric character, or a predetermined symbol. Predetermined symbol shapes may include shapes indicative of the following actions: power on, power off, initiate call, end call, camera mode, video mode, volume control, and musical playback.

In accordance with embodiments of the invention, the actuation element 106 described herein is configured to alter the actuation element profile 108 relative to the housing 102 in response to a device event 110. This alteration of the actuation element profile 108 may occur in many ways. For example, in one embodiment, the actuation element profile 108 may be altered by extending the actuation element 106 distally from the housing 102. Alternate embodiments for altering the actuation element profile 108 will be discussed in further detail below. In each embodiment, however, following the alteration of the actuation element profile 108, the actuation element retains an actuation element actuation state 112.

The actuation element actuation state 112 is a state of control associated with the actuation element 106. For instance, where the actuation element 106 is a power button prior to altering its actuation element profile 108, the actuation element 106 will still be a power button after the actuation element profile 108 is altered. Similarly, in the case of a mobile telephone, when the actuation element 106 is a “9 WXY” button prior to altering its actuation element profile 108, the actuation element 106 will continue to be a “9 WXY” button after the actuation element profile 108 is altered.

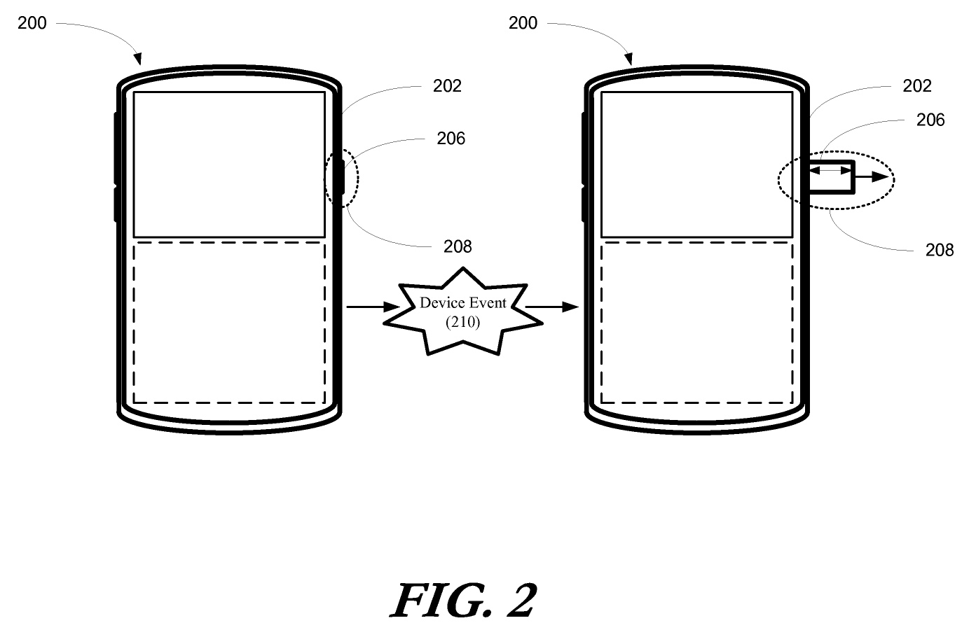

Turning briefly to FIG. 2, illustrated therein is one embodiment of an actuation element 206 changing its actuation element profile 208 relative to a housing 202 of an electronic device 200 in response to a device event while retaining its actuation element state. In FIG. 2, the electronic device 200 has an actuation element 206 initially residing in a relatively flush relationship with a housing 202. The actuation element 206 is capable of controlling at least one device function. The control of this function defines the actuation element's actuation element actuation state.

In response to a device event 210, such as an incoming call or e-mail, the actuation element 206 in one embodiment extends distally from the housing 202 by a predetermined distance, such as one-half inch, thereby altering the actuation element profile 208. After this extension, the actuation element 206 is still capable of controlling the original device function, and thus retains its actuation element actuation state.

The illustrative embodiment shown in FIG. 2 is that of the actuation element 206 extending distally from the side of a “candy bar” style electronic device. It will be clear to those of ordinary skill in the art having the benefit of this disclosure, however, that the invention is not so limited. In one embodiment, for instance, the electronic device comprises a hinged “flip style” housing. In such an embodiment, the actuation element may be disposed on the inside of one half of the hinged housing. As such, the actuation element rests in an initial actuation element profile when the hinged housing is closed. In response to the device event, the actuation element may extend distally from the hinged housing, thereby altering the actuation element profile and separating the two halves of the hinged housing. Closing the two halves of the hinged housing depresses the actuation element and returns it to the initial actuation element profile.

Turning back to FIG. 1, in one embodiment, the device event 110, as briefly mentioned above, is an event that requires a user to take an action or to make a decision. Where the device event 110 is an incoming phone call, for example, the user may be requested to accept or ignore the call. Examples of device events include: an incoming call, an incoming text message, an incoming multimedia message, a call in progress, an availability of a personal area network or other data transfer services, a change of the cellular channel or provider, an expiration of a timer, a calendar alarm event, or a low battery warning.

In one embodiment, the user interface 104 comprises a plurality of actuation elements 114. Each of the plurality of actuation elements 114 is configured to control a corresponding device function, such as entering or deleting a typed character. The device function may be user definable. Further, the actuation element 106 that changes its actuation element profile 108 in response to the device event may also be user definable. For example, one of the plurality of actuation elements 114 may be configured as the “answer call” button because it is easily accessible by the user's finger when viewing the display 105. However, a change in the actuation element profile of this actuation element may not be easily “felt” when the electronic device 100 is in the user's pocket. To overcome this, the user may select another actuation element to change profile when incoming calls are received. Further, multiple actuation elements may be selected to alter their actuation element profile in response to a device event. For instance, three actuation elements may be selected to change their respective actuation element profiles—at different times—in response to an incoming phone call, thereby creating a “wave-like” effect.

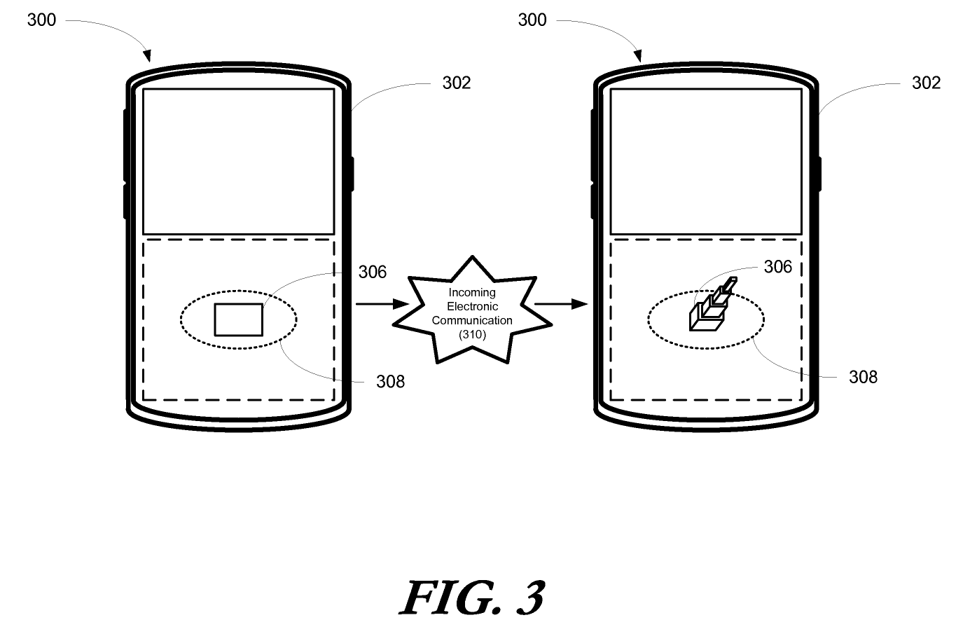

In one embodiment, the alteration of the actuation element profile 108 prompts the user for at least one of a plurality of responses. The user may then actuate the actuation element 106 to signal a response. By way of example, turning now to FIG. 3, illustrated therein is a radiotelephone 300 capable of electronic communication. The actuation element of interest is a call activation key 306 configured to answer incoming calls. The call activation key 306 is configured to alter its actuation element profile 308 relative to the housing 302 in response to an incoming communication 310. Upon receipt of the incoming communication 310, the call activation key 306 extends telescopically from the housing 302, thereby altering its actuation element profile 308. The user is thus prompted to answer the incoming communication 310 by pressing or otherwise actuating the call activation key 306. In one embodiment, the mechanism for altering the actuation element profile 308 is a nested slide, driven by a piezoelectric micro-motor.

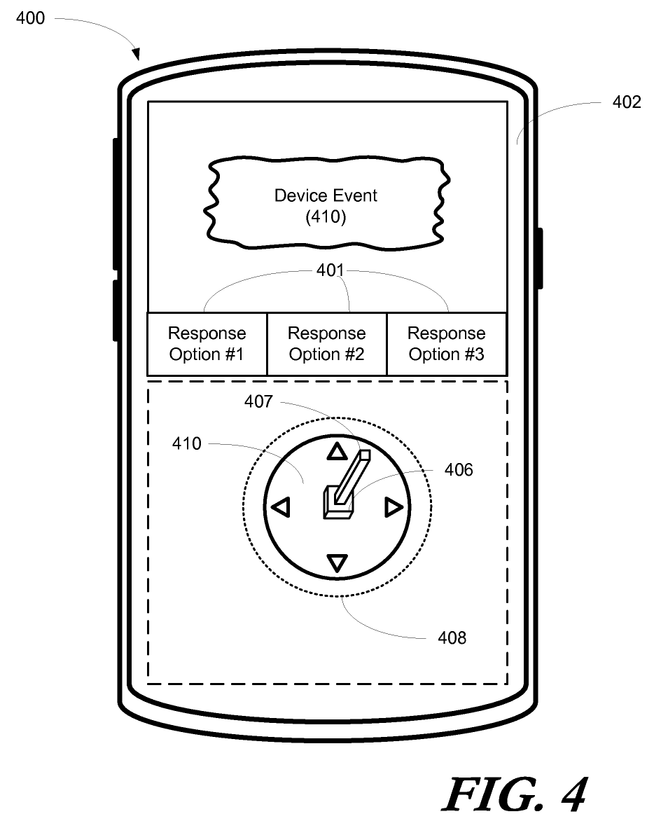

Turning to FIG. 4, illustrated therein is another embodiment of an electronic device 400 comprising an actuation element 406 configured to alter its actuation element profile 408 with respect to a housing 402 in response to a device event 410. In one embodiment, the user may be prompted for one of a plurality of responses 401 to the device event 410. To facilitate the selection, the actuation element 406 is configured as a navigation key 407. The navigation key 407 is suitable for navigation among the plurality of options suitable for response 401. In one embodiment, the navigation key 407 includes a navigation wheel 412 capable selecting from the plurality of options suitable for response 401. In one embodiment, the navigation key 407 is actuated by pressing the navigation key 407 downward to select of one of the plurality of options suitable for response 401.

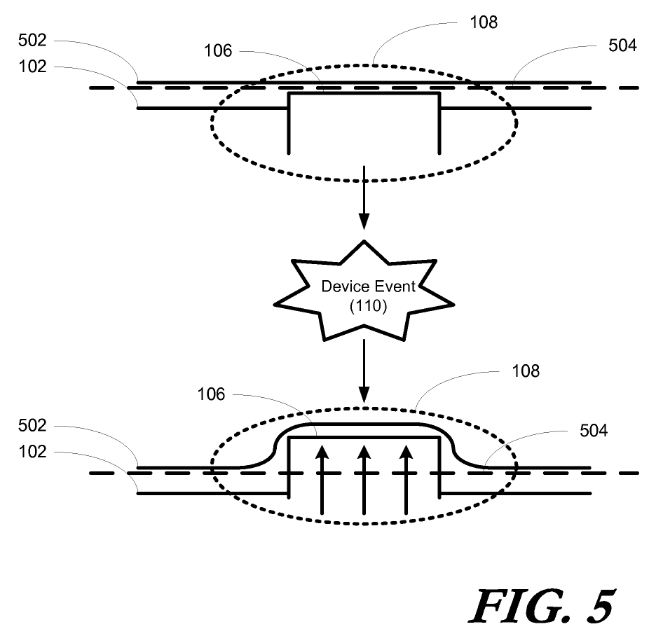

While extending an actuation element distally from the housing is one mechanism for altering the actuation element profile, other mechanisms exist as well. Turning now to FIG. 5, illustrated therein is one such alternate mechanism. In FIG. 5, a housing 102 comprises a deformable cover layer 502. The deformable cover layer 502 is configured to cover all or at least a portion of the housing 102. The deformable cover layer 502 may vary in texture, thickness, material, composition, and optical characteristics. In one embodiment, the deformable cover layer 502 is a thin, semitransparent layer of flexible material, such as rubber, configured to cover, while permitting visibility, the actuation element 106. In another embodiment, the deformable cover layer is an opaque material, such that the actuation element 106 is not seen until its actuation element profile 108 is altered.

Following a device event 110, the actuation element 106 alters the actuation element profile 108, thereby deforming the deformable cover layer 502. In one embodiment, the deformable cover layer 502 rests on a plane 504 parallel to the housing 102. Upon the altering of the actuation element profile 108, the deformable cover layer 502 deforms, thereby creating a shape that is non-coplanar with the plane 504.

Many actuation element profile drivers, mechanisms, and engines are capable of altering the actuation element profile (108), as illustrated in FIG. 2, FIG. 3 and FIG. 5. In one embodiment for example, distal extension of the actuation element (106) is implemented by a piezoelectric driver. Other drivers may also be used, including an electromagnetic driver, an electrostatic driver, a shape memory alloy driver, an electrorheological driver, and an electroactive polymer driver. It will be clear to those of ordinary skill in the art having the benefit of this disclosure that other devices may be used to alter the actuation element profile (108) as well.

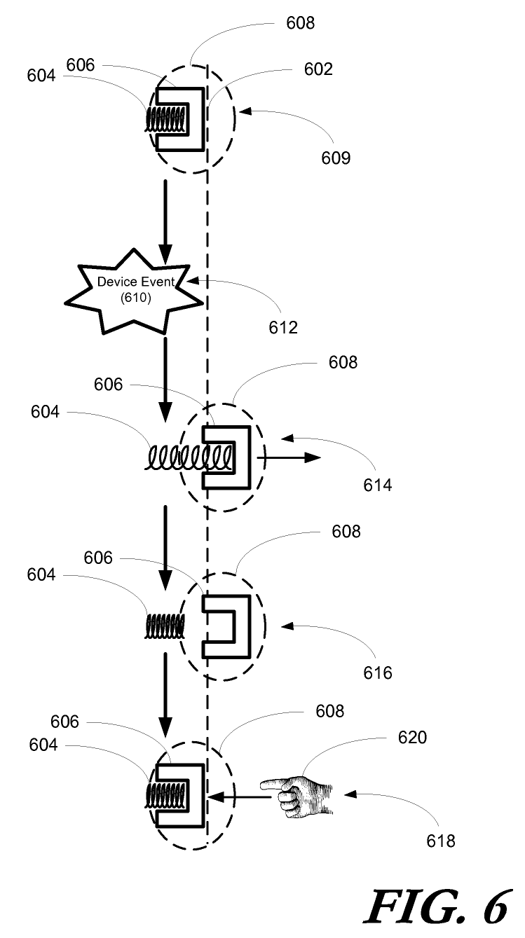

Turning to FIG. 6, illustrated therein is one embodiment of an actuation element profile driver implemented to alter the actuation element profile 608 with respect to the housing 602. The actuation element profile driver comprises a shape memory alloy spring 604. In some embodiments, such as the one illustratively shown in FIG. 6, the actuation element profile driver is bistable. It is “bistable” in that it is configured to enter a low power mode after altering the actuation element profile 608. The shape memory alloy spring 604 is a bistable actuation element having two stable states. The two stable states are a compacted shape memory alloy spring (the low power mode), and an extended shape memory alloy spring (the actuated mode).

The exemplary shape memory alloy spring 604 of FIG. 6 is made of martensite and is situated in a first profile state at step 609. In one embodiment, when the shape memory alloy spring 604 is in the first profile state, it is in the low power mode because energy is not continually required to maintain the first profile state. In response to a device event 610, at step 612, the shape memory alloy spring 604 is heated by a driver, causing the martensite to change into a memorized austenite phase, thereby elongating the shape memory alloy spring 604. The elongation of the shape memory alloy spring 604 creates an outward force on the actuation element 606, thereby causing it to enter a second profile state at step 614. Upon cooling at step 616, the shape memory alloy spring 604 returns to the first profile state. At step 618, the actuation element 606 is depressed by a user 620 and an electrical signal associated with the actuation element 606 is transmitted.

Note that there are many additional embodiments of shape memory alloy drivers for use with embodiments of the invention. In one embodiment, the shape memory alloy driver comprises a pump. The pump further comprises a cylinder, a piston, a shape memory alloy element, a spring and an end-cap with electrical terminals. The end-cap tightly seals the cylinder. The shape memory alloy element is engaged with the piston on one side and connected with the end-cap terminals on the other side. When voltage is supplied to the electrical terminals, the shape memory alloy element is heated. After reaching a critical temperature, the shape memory alloy element changes length. This moves the piston from one position in the cylinder to another position. The movement of the cylinder creates a force which the pump can use to alter the actuation element profile (108). After the voltage is removed, the shape memory alloy element cools and recovers its original length. Thus, the piston returns to the initially end position.

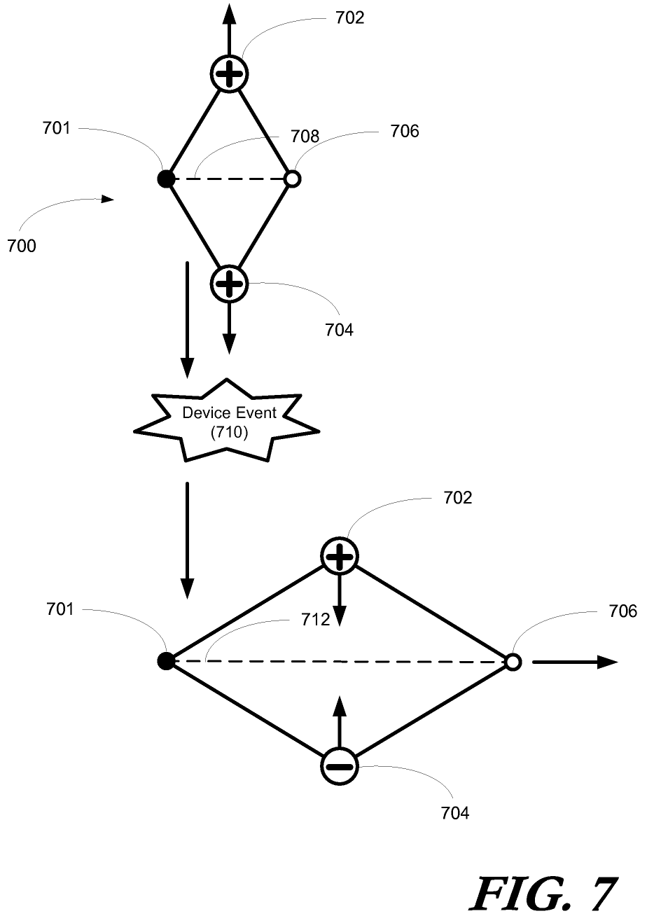

Turning to FIG. 7, illustrated therein is one embodiment of an actuation element profile driver comprising an electromagnetic driver 700. The electromagnetic driver 700 comprises a fixed pivot 701, a first electromagnet 702 with a first charge, a second electromagnet 704 with a first charge, and an actuation element 706. The first electromagnet 702 and the second electromagnet 704 are connected at fixed distances to both the fixed pivot 701 and the actuation element 706.

Initially both holding the first charge, the first electromagnet 702 and the second electromagnet 704 repel each other, thus creating a first distance 708 between the fixed pivot 701 and the actuation element 706. In response to a device event 710, one of the electromagnets is given an opposite charge from that which it initially held. The first electromagnet 702 and the second electromagnet 704, now holding opposite charges, attract each other. This attraction causes the actuation element 706 to extend distally outward to a second distance 712 from the fixed pivot 701.

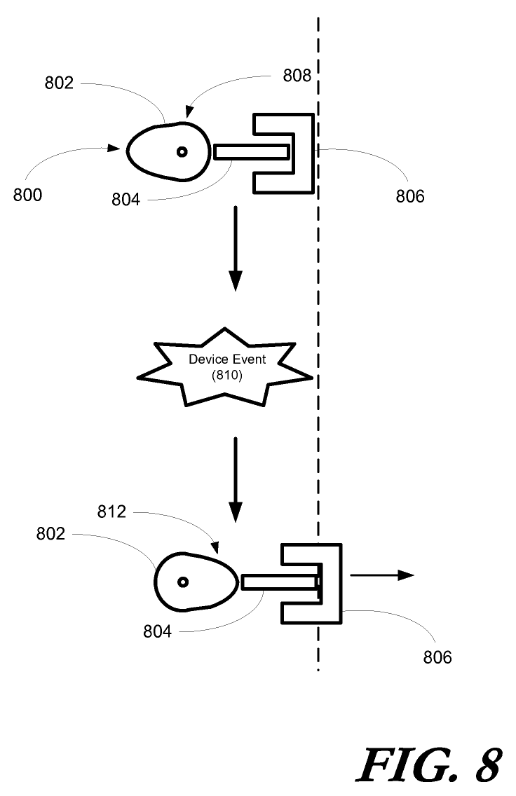

In one embodiment, distal extension of the actuation element (106) is implemented by an actuation element profile motor. The actuation element motor may comprise, but is not limited to, a cam and follower motor, a worm-gear motor, a pivot and retraction motor or a bellows device. Turning briefly to FIG. 8, illustrated herein is one embodiment of an actuation element profile motor comprising a can and follower motor 800. The cam 802 and follower 804 are illustrated. At a first position 808, the follower 804 rests on the inherently circular surface of the cam 802 and the follower 804 is in contact with an actuation element 806.

In response to a device event 810, the cam 802 rotates to a second position 812. At the second position, the follower 804 rests on the inherently oblong surface of the cam 802, thus distally extending the follower and in turn the actuation element 806. In one embodiment, upon reaching the second position 812, the cam 802 rotates back to the first position 808, thereby returning the follower 804 its original position as well. In one embodiment, the follower 804 comprises a spring configured to keep the follower 804 in contact with the cam 802 at all times. The actuation element 806 may remain in an actuated position even though the follower has returned to its initial position. The actuation element 806 may return to its initial position when depressed by a user.

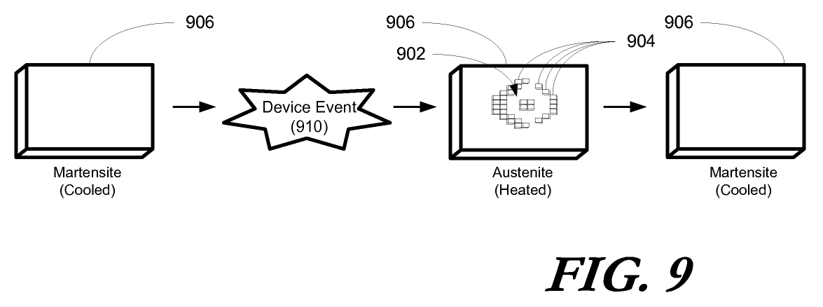

Turning to FIG. 9, illustrated therein is one embodiment of an actuation element 906 configured to alter the actuation element profile by changing an actuation element form factor. In FIG. 9, altering the actuation element profile by changing its actuation element form factor includes manipulating the surface characteristics of the actuation element 906. There are many methods for manipulating the surface of the actuation element 906, including the application of heat, the application of an electrical charge, or inflation of the actuation element 906.

In one embodiment, changing the actuation element form factor involves a raised symbol 902 appearing on the surface of the actuation element 906. By way of example, an actuation element may comprise a balloon-like and/or an elastic surface with a play button symbol molded into the balloon-like surface. At an initial state, the actuation button is deflated, thereby preventing the play button symbol from being visible. In response to a device event, air is pumped into the actuation button and the balloon-like surface inflates. The play button symbol expands past the circumference of the actuation button and become visible.

In one embodiment, the raised symbol 902 comprises a plurality of raised bumps 904. One example of an embodiment implementing a plurality of raised bumps is a method utilizing a bistable material as the surface of the actuation element 906. One example of such a method, as described above, involves covering the actuation element 906 with a layer of martensite. A plurality of micrometer dents, placed in a grouping resembling a symbol describing functionality, is imprinted onto the surface of the martensite actuation element 906. A flattening technique using mechanical polishing call “planarizing” is used to smooth the martensite surface such that the dents are not visible. In response to a device event 910, the martensite is heated to a critical temperature when the martensite becomes austenite. Upon becoming austenite, the plurality of dents becomes a plurality of raised bumps 904 on the surface of the actuation element 906. When the austenite is cooled to martensite, in one embodiment, upon a user depressing the actuation button 906, the plurality of raised bumps 904 disappear.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. An electronic device comprising a housing having a user interface, the user interface having an actuation element for controlling at least one device function, wherein the actuation element is configured to alter an actuation element profile relative to the housing in response to a device event while retaining an actuation element actuation state.

2. The electronic device of claim 1, wherein the user interface comprises a plurality of actuation elements, wherein the actuation element configured to alter the actuation element profile is one of the plurality of actuation elements and is user definable.

3. The electronic device of claim 1, wherein the housing comprises a deformable cover layer that covers at least a portion of the housing, wherein the actuation element configured to alter the actuation element profile is disposed beneath the deformable cover layer so as to deform the deformable cover layer upon changing the actuation element profile.

4. The electronic device of claim 1, wherein the alteration in the actuation element profile prompts a user for at least one of a plurality of responses.

5. The electronic device of claim 4, wherein the electronic device comprises a radiotelephone, wherein the actuation element comprises a call activation key, further wherein the device event comprises an incoming electronic communication.

6. The electronic device of claim 1, wherein the actuation element comprises a bistable actuation element configured to enter a low-power mode after changing the actuation element profile.

7. The electronic device of claim 1, wherein the actuation element is capable of user actuation to control the at least one device function both before altering the actuation element profile and after altering the actuation element profile.

8. The electronic device of claim 1, wherein the alteration in the actuation element profile comprises an increased distal extension from the housing.

9. The electronic device of claim 8, wherein the increased distal extension from the housing comprises a telescopic extension from the housing.

10. The electronic device of claim 8, further comprising an actuation element profile driver coupled to the actuation element, wherein the actuation element profile driver is one of a piezoelectric driver, an electromagnetic driver, an electrostatic driver, a shape memory alloy driver, an electrorheological driver, or an electroactive polymer driver.

11. The electronic device of claim 8, further comprising an actuation element profile motor coupled to the actuation element, wherein the actuation element profile motor is one of a cam and follower motor, a worm-gear motor, a pivot and retraction motor, or a bellows device.

12. The electronic device of claim 1, wherein the housing comprises a hinged housing configured such that, upon the actuation element changing the actuation element profile, closing the hinged housing causes the actuation element to return to an initial actuation element profile.

13. The electronic device of claim 1, wherein in the actuation element configured to alter the actuation element profile by changing an actuation element form factor.

14. The electronic device of claim 1, wherein the electronic device comprises a radiotelephone, further wherein the device event is one of an incoming telephone call, an incoming text message, an incoming multimedia message, a low battery warning, or a calendar alarm event.

15. The electronic device of claim 1, wherein the actuation element comprises a navigation key for navigating among a plurality of options suitable for response to the device event.

16. The electronic device of claim 1, wherein the actuation element comprises an actuation element cross sectional shape which is one of a ramp, rectangle, plus, circle, semicircle, triangle, oval, alphanumeric character shape, or predetermined symbol shape.

17. A radiotelephone comprising a housing and a plurality of user actuation elements, wherein at least one user actuation element is configured to alter an actuation element profile relative to the housing from a first profile to a second profile in response to a device event, thereby altering a form factor of the radiotelephone so as to provide a physical notification that the device event has occurred.

18. The radiotelephone of claim 17, further comprising an environmental sensor, wherein when the environmental sensor is in a first state, the at least one user actuation element comprises a first user actuation element, wherein when the environmental sensor is in a second state, the at least one user actuation element comprises a second user actuation element, wherein the first user actuation element and the second user actuation element are different.

19. The radiotelephone of claim 17, wherein the second profile comprises a projection of the at least one user actuation element from the first profile.
